(19) United States
(12) Patent Application Publication
(10) Pub. No.: US 2020/0052514 A1
(43) Pub. Date: Feb. 13, 2020

(54) ELECTRIC DRILL AND DOCK

(71) Applicant: NAIL ALLIANCE, LLC, Gladstone, MO (US)

(72) Inventor: Danny Lee HAILE, La Habra, CA (US)

(73) Assignee: NAIL ALLIANCE, LLC, Gladstone, MO (US)

(21) Appl. No.: 16/537,233

(22) Filed: Aug. 9, 2019

Related U.S. Application Data
(63) Continuation of application No. 29/659,567, filed on Aug. 9, 2018.

(51) Int. Cl. H02J 7/00; A45D 29/05

(52) U.S. Cl. CPC H02J 7/0044; A45D 29/05

(57) ABSTRACT

An electric drill dock system including a power pack having one or more battery cells disposed therein. The power pack can have a vertical length, a horizontal length, and a depth length defining a power pack footprint formed by the vertical length and a horizontal length. A docking station can be operable to receive at least a portion of the power pack therein, the docking station having a footprint. A tool can be operably coupled with the power pack via a power cable operably coupling the power pack with the tool, and the docking station footprint is less than the power pack footprint.

### CROSS-REFERENCE TO RELATED APPLICATIONS

This application claims the benefit of U.S. application Ser. No. 29/659,567, filed Aug. 9, 2018, the contents of which are incorporated by reference herein in their entirety.

### FIELD

The present disclosure relates generally to apparatuses and systems for electric drills and/or docks. More specifically, the present disclosure relates to apparatuses and systems for electric drills and/or docks for use as personal care devices.

### BACKGROUND

Nail salons and nail technicians can use a variety of devices during a personal care treatment, including an electric drill/file device for use during a manicure. These electric drills can be cordless/wireless, thus allowing freedom of movement during the personal care treatment. However, the battery back of the electric drill device can take up a significant portion of a nail technician's work space.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative examples, in which the principles of the disclosure are utilized, and the accompanying drawings of which:

FIG. 1 is an isometric view of an electric drill dock system according to at least one instance of the present disclosure;

FIG. 2 is an isometric view of an electric drill dock, according to at least one example of the present disclosure; and

FIG. 3 is a top planar view of an electric drill dock system, according to at least one example of the present disclosure.

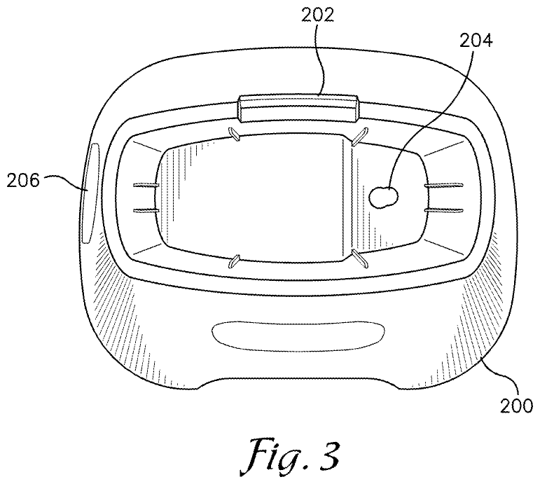

### DETAILED DESCRIPTION

Examples and various features and advantageous details thereof are explained more fully with reference to the exemplary, and therefore non-limiting, examples illustrated in the accompanying drawings and detailed in the following description. Descriptions of known starting materials and processes can be omitted so as not to unnecessarily obscure the disclosure in detail. It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

Additionally, any examples or illustrations given herein are not to be regarded in any way as restrictions on, limits to, or express definitions of, any term or terms with which they are utilized. Instead these examples or illustrations are to be regarded as being described with respect to one particular example and as illustrative only. Those of ordinary skill in the art will appreciate that any term or terms with which these examples or illustrations are utilized encompass other examples as well as implementations and adaptations thereof which can or cannot be given therewith or elsewhere in the specification and all such examples are intended to be included within the scope of that term or terms. Language designating such non-limiting examples and illustrations includes, but is not limited to: “for example,” “for instance,” “e.g.,” “In some examples,” and the like.

The present disclosure is drawn to a drill dock system. The drill dock system can include an electric drill and/or file communicatively coupled with a power pack. The power pack can include a rechargeable battery and have a top surface and a bottom surface exceeding a thickness surface. A power cable can communicatively couple the electric drill with the power pack and have a predetermined length. The power cable can be operable transmit power from the power back to the electric drill. The power pack can be operably received within a dock, thereby arranging the thickness surface area in substantially vertical arrangement and minimizing the top surface and bottom surface on a substantially horizontal surface.

The dock can be operable to have one or more couplers disposed therein. In some instances, the one or more couplers can include a power coupling operable to charge the power pack while in the dock. In some instances, the one or more couplers can include one or more latch mechanisms operable to secure the power pack within the dock. In yet other instances, the one or more couplers can be a combination of power couplings, and/or latch mechanisms.

The electric drill can include a motor operable to drive one or more attachments including, but not limited to, a file, sanding pad, buffing pad, and/or the like. In at least one instance, the drill dock system can include a processor operable to control the speed of the electric drill, and/or the one or more attachments. In some instances, the processor can be disposed within the power pack. In other instances, the processor can be disposed within the electric drill.

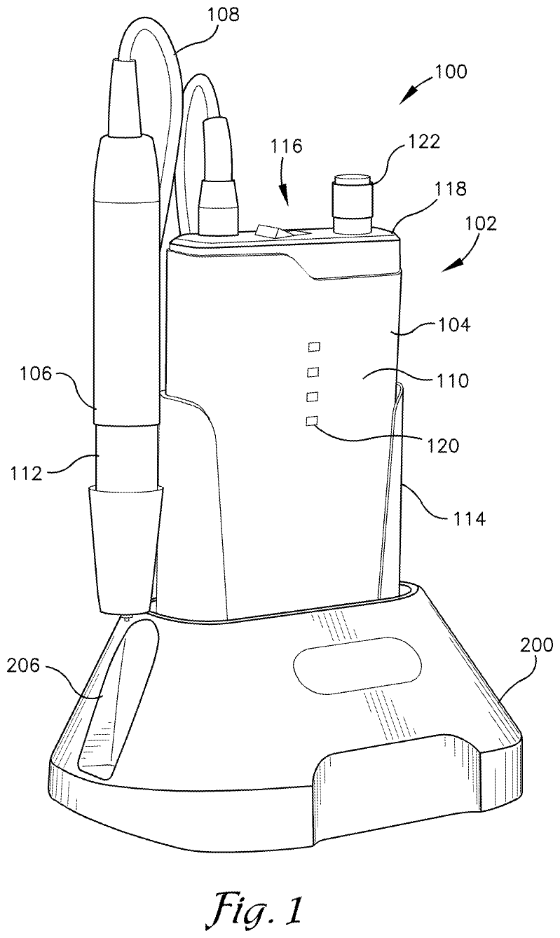

FIG. 1 illustrates a drill dock system according to at least one instance of the present disclosure. The drill dock system 100 can include an electric drill 102 and a dock 200. The electric drill 102 can include a power pack 104 and a tool 106. The power pack 104 can be communicatively coupled with the tool 106 and operable to transfer power from the power pack 104 to the tool 106. In at least one instance, the power pack 104 is operable to transfer electric power (e.g. current) to the tool 106. In other instances, the power pack 104 can be operably arranged to transfer mechanical power (e.g. revolutions per minute (RPM)) to the tool 106.

A power cable 108 can communicatively couple the power pack 104 with the tool 106. The power cable 108 can have a predetermined length, thereby allowing the tool 106 to have a useful range away from the power pack 104. The power cable 108 can be operably arranged to communicatively couple electric and/or mechanical power from the power pack 104 to the tool 106. In at least one instance, the power cable 108 can have a rotational element disposed therein along the predetermined length transferring rotational mechanical power generated at the power pack 104 to the tool 106.

In other instances, the power cable 108 can be one or more electrical cables operably arranged to transfer electrical power from the power pack 104 to the tool 106. In at least some instances, the power cable 108 can be operably arranged to transfer a combination of mechanical and/or electrical power from the power pack 104 to the tool 106.

The power pack 104 can include one or more rechargeable battery cells 110 operable to store electrical energy. The power pack 104 can be a single large battery cell or an array of smaller battery cells operably coupled together to act as a larger battery. The one or more rechargeable battery cells can be Nickel metal hydride (NiMH), Nickel-cadmium (NiCad), Lithium-ion (Li-ion), and/or any other battery chemistry desirable for implementation in high power, long battery life applications.

The drill dock system 100 can have a motor 112 communicatively coupled with the one or more rechargeable battery cells 110. In at least one instance, the motor 112 can be disposed within the tool 106 and be communicatively coupled with the power pack 104 and the one or more battery cells 110 via the power cable 108. The tool 106 and/or the power pack 104 can have a processor operable to control the speed of the electric drill 102, and/or one or more attachments.

In other instances, the motor 112 can be disposed within the power pack 104 and operable to produce rotational power to be transferred from the power pack 104 to the tool 106 via the power cable 108. The power pack 104 and/or the tool 106 can additionally include one or more processors operable to control the speed of the electric drill 102, and/or the one or more attachments.

The power pack 104 can have an indicator 120 operable to display a charge level of the one or more battery cells 110 and/or a representation thereof. In at least one instance, the indicator 120 can be a plurality of illuminators wherein more illuminators indicate a increased charge level relative to a less illuminators.

In some instances, the power pack 120 can have a control knob 122 operable to control speed of the motor 112 and/or the electric drill 102. The control knob 122 can be operably coupled with the processor, thus allowing a user precise control of the rotational speed of the motor and/or electric drill 102 for individual attachments. In other instances, the control knob 122 can be a touch-sensitive control and/or series of buttons operable to receive an input relative to increase and/or decrease operational speed of the electric drill 102, motor 112, and/or tool 106.

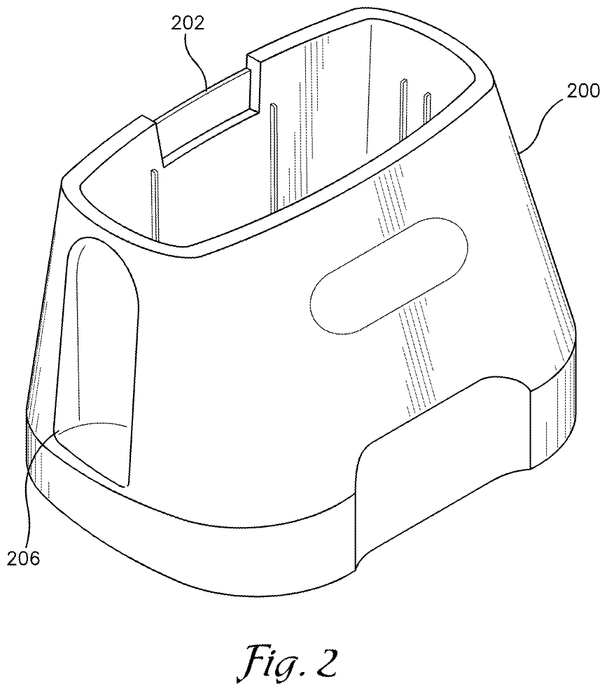

The docking station 200 can be operable to reduce the footprint of the power pack 104. As can be appreciated in FIGS. 1 and 2, the power pack 104 can have a vertical length 114, a horizontal length 116, and a depth length 116, while the docking station 200 can be operable to receive the power pack 104 in a substantially vertical arrangement, thus reducing the footprint of the power pack 104 relative to a surface supporting the docking station 200.

FIG. 2 illustrates an electric drill dock coupled with a docking station according to at least one instance of the present disclosure. The drill dock system 100 can include a docking station 200 operable to receive at least a portion of the power pack 104 therein. the docking station 200 can be operably arranged to receive at least a portion of the power pack 104, and maintain the power pack 104 in a substantially vertical arrangement, thus minimizing the power pack 104 foot print on a surface. The docking station 200 can have a footprint sufficiently larger than the power pack 104 in a vertical position to ensure stability of the power pack 104, and thus prevent tipping of the power pack 104 and docking station 200.

In some instances, the docking station 200 can include one or more couplers operable to engage the power pack 104. The one or more couplers can include a latch mechanism 202 operable to couple the power pack 104 with the docking station 200. The one or more couplers can include a power coupler 204 operable to couple the one or more battery cells 110 of the power pack 104 with an A/C, D/C, and/or battery device operable to charge the power pack 104. In some instances, the power coupler 204 can be a micro-USB male-female coupling, with the power pack 104 having a female micro-USB port disposed thereon and the docking station 200 having a male micro-USB port disposed thereon and operable to engage the female micro-USB port on the power pack 104, thereby allowing the one or more battery cells 110 to receive charge via the docking station 200. In other instances, any power coupler operable to transfer power between two elements when coupled, known and/or proprietary, can be implement with the docking station 200 and the power pack 104, respectively.

In some instances, the docking station 200 can further include a tool rest 206 operable to receive, secure, and/or otherwise couple at least a portion of the tool 106 with the docking station 200. The tool rest 206 can be operable to receive a portion of the tool 106 for storage during charging and/or during periods of non-use, thus further reducing the footprint of the drill dock system on a working surface.

The docking station 200 can substantially reduce the power pack 104 footprint on a surface upon which the docking station 200 is disposed. The power pack 104 footprint can generally be defined as a surface area exposed by the vertical length 114 and the horizontal length 116. The docking station 200 maintaining the power pack 104 in a substantially vertical arrangement reduces the overall footprint of the power pack 104 simply by exposing a surface area defined by the depth length 116 and the horizontal length 114.

While the present disclosure generally describes and illustrates the power pack 104 receivable within the dock 200 in a substantially vertical position, it is within the scope of this disclosure to also implement the power pack 104 in a substantially horizontal position which similarly reduces the overall footprint of the power pack 104 on a surface.

Reduction of the footprint on a surface can improve usability and efficiency of a workspace by a user, while preventing having to constantly move and rearrange the power pack 104 within a workspace. Further, the docking station can similarly provide a charging station while the drill dock system 100 is being used and/or stored, and maintain this position when the drill dock system is being stored.

While preferred examples of the present disclosure have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

What is claimed is:

1. An electric drill dock system comprising:
a power pack having one or more battery cells disposed therein, the power pack having a vertical length, a horizontal length, and a depth length, a power pack footprint formed by the vertical length and a horizontal length;
a docking station operable to receive at least a portion of the power pack therein, the docking station having a footprint;
a tool operably coupled with the power pack via a power cable operably coupling the power pack with the tool,
wherein the docking station footprint is less than the power pack footprint.

2. The electric drill dock system of claim 1, wherein the docking station operably receives at least a portion of the power pack in a substantially vertical position.

3. The electric drill dock system of claim 1, wherein the docking station operably receives at least a portion of the power pack in a horizontal vertical position.

4. The electric drill dock system of claim 1, further comprising a motor disposed within the power pack, the motor operable to transfer mechanical power to the tool via the power cable.

5. The electric drill dock system of claim 4, wherein the power cable has rotational shaft disposed therein, the rotational shaft coupling the motor and the tool and operable to transfer rotational power from the motor to the tool.

6. The electric drill dock system of claim 1, further comprising a motor disposed within the tool, the motor operable to receive electrical power from the one or more battery cells via the power cable.

7. The electric drill dock system of claim 1, wherein the one or more battery cells are a plurality of battery cells arranged in an array.

8. The electric drill dock system of claim 1, wherein the dock station includes a tool rest operable to receive at least a portion of the tool.

9. The electric drill dock system of claim 1, wherein the dock station includes a latch operable to engage at least a portion of the power pack, thereby securely coupling the dock station and the power pack.

10. The electric drill dock system of claim 1, wherein the dock station includes a power coupler operable to engage a corresponding power pack coupler.

11. An electric drill dock system comprising:
a power pack having one or more battery cells disposed therein, the power pack having a vertical length, a horizontal length, and a depth length, a power pack footprint formed by the vertical length and a horizontal length;
a docking station operable to receive at least a portion of the power pack therein, the docking station having a footprint;
a tool operably coupled with the power pack via a power cable operably coupling the power pack with the tool; and
a motor operably coupled with the tool to power one or more attachments coupled with the tool,
wherein the docking station footprint is less than the power pack footprint.

12. The electric drill dock system of claim 11, wherein the docking station operably receives at least a portion of the power pack in a substantially vertical position.

13. The electric drill dock system of claim 11, wherein the docking station operably receives at least a portion of the power pack in a horizontal vertical position.

14. The electric drill dock system of claim 11, wherein the motor disposed within the power pack, the motor operable to transfer mechanical power to the tool via the power cable.

15. The electric drill dock system of claim 14, wherein the power cable has rotational shaft disposed therein, the rotational shaft coupling the motor and the tool and operable to transfer rotational power from the motor to the tool.

16. The electric drill dock system of claim 11, wherein the motor disposed within the tool, the motor operable to receive electrical power from the one or more battery cells via the power cable.

17. The electric drill dock system of claim 11, wherein the one or more battery cells are a plurality of battery cells arranged in an array.

18. The electric drill dock system of claim 11, wherein the dock station includes a tool rest operable to receive at least a portion of the tool.

19. The electric drill dock system of claim 11, wherein the dock station includes a latch operable to engage at least a portion of the power pack, thereby securely coupling the dock station and the power pack.

20. The electric drill dock system of claim 11, wherein the dock station includes a power coupler operable to engage a corresponding power pack coupler.
